(19) United States
(12) Patent Application Publication
(10) Pub. No.: US 2003/0194517 A1
(43) Pub. Date: Oct. 16, 2003

(54) Coating compositions containing a silane additive and structures coated therewith

(76) Inventors: Yu Shi, Atlanta, GA (US); Ronald J. Valus, Valley View, OH (US); John V. Standish, Hudson, OH (US)

Correspondence Address: SUTHERLAND ASBILL & BRENNAN LLP, 999 PEACHTREE STREET, N.E., ATLANTA, GA, 30309, US

(21) Appl. No.: 10/122,856

(22) Filed: Apr. 15, 2002

(51) Int. Cl. B32B 1/02

(52) U.S. Cl. 428/35.7; 428/447

(57) ABSTRACT

Coatings are provided to give inorganic oxide coated polymeric structures a top coat that improves the gas barrier properties of the structure while enhancing the water resistance of the top coating and while improving the adhesion of the top coat to an inorganic oxide substrate layer. These top coat compositions comprise an organic compound in combination with a silane additive which crosslinks the organic compound with the inorganic oxide. Multilayer structures having this top coat are also provided, particularly in the form of containers for food and beverage packaging.

### TECHNICAL FIELD

This invention relates to plastic films and containers, such as beverage containers, that include a barrier coating to reduce gas permeation therethrough, and more particularly to top coat materials for enhancing the performance properties of the barrier coating.

### BACKGROUND OF THE INVENTION

Plastic containers comprise a large and growing segment of the food and beverage industry. Plastic containers offer a number of advantages over traditional metal and glass containers. They are lightweight, inexpensive, non-breakable, transparent, and easily manufactured and handled. Plastic containers have, however, at least one significant drawback that has limited their universal acceptance, especially in the more demanding food applications. That drawback is that all plastic containers are more or less permeable to water, oxygen, carbon dioxide, and other gases and vapors. In a number of applications, the permeation rates of affordable plastics are great enough to significantly limit the shelf life of the contained food or beverage, or prevent the use of plastic containers altogether.

Plastic bottles have been constructed from various polymers, predominantly PET, for non-carbonated and particularly for carbonated beverages. All of these polymers, however, exhibit various degrees of permeability to gases and vapors, which have limited the shelf life of the beverages contained within them. For example, carbonated beverage bottles have a shelf life that is limited by loss of CO₂. (Shelf life is typically defined as the time needed for a loss of seventeen percent of the initial carbonation of a beverage.) For non-carbonated beverages, similar limitations apply due to oxygen and/or water vapor diffusion. Diffusion means both ingress and egress (diffusion and infusion) to and from the bottle or container. It would be desirable to have a container with improved gas barrier properties.

A number of technologies have been developed to decrease the permeability of polymers, and thus increase their range of applicability to food and beverage packaging. (Permeability decrease is equivalent to barrier increase.) One of the most promising approaches has been the deposition of thin layers of inorganic oxides on the surface of the polymers, either before or after mechanically forming the polymer into the finished container. See, e.g., PCT WO 98/40531. Inorganic oxides, especially silicon dioxide, have been explored extensively, because of their transparency, impermeability, chemical inertness, and compatibility with food and beverages. Commercialization of containers based on polymeric/inorganic oxide multilayer structures, however, has been slow and mostly limited to flexible containers made by post-forming coated films.

In particular, rigid polymeric containers with inorganic oxide coatings have proven difficult to develop. Despite the relative ease of depositing inorganic oxides onto the exterior surface of a rigid container, those containers have not exhibited sufficient reductions in permeability over the uncoated containers. This modest decrease in permeability is due to the presence of residual pinholes in the inorganic oxide layer. Pinholes are created, in part, by pressurization of containers-such as when containers hold carbonated beverages. The surface area occupied by these pinholes is usually quite small (on the order of less that 1% of the total surface); however, the impact of these pinholes is far greater than their surface area would suggest, because diffusion through a polymer occurs in all three spatial dimensions. Each pinhole therefore can drain a much larger effective area of the container surface than the actual area of the pinhole.

Several methods have been explored to address the pinhole problem. The most common approach has been to deposit thicker layers of the oxide; however, this approach is inherently self-defeating. Thicker layers are less flexible and less extensible than thin layers, and therefore more prone to fracturing under stress. Another method is to apply multiple layers of inorganic oxides, sometimes with intermediate processing to redistribute the pinhole-causing species. This approach also has met with little success, in part, because of the greater complexity of the process and because of its modest improvement in barrier performance. A third method has been to supply an organic sub-layer on the polymer surface to planarize the surface and cover up the pinhole-causing species prior to laying down the inorganic oxide. This method also greatly increases the complexity and cost of the overall process, with only modest improvement in barrier performance. A fourth approach has been to melt-extrude a second polymer layer on top of the inorganic oxide layer, in order to provide additional resistance to gas flow through the pinholes.

With this fourth approach, it has been reported that applying a 4 micron layer of poly(ethylene-co-vinyl acetate) on top of a PET/SiOₓ structure improved the barrier property by 3×, and applying a 23 micron top layer of PET improved the barrier performance by 7× (Deak & Jackson, Society of Vacuum Coaters, 36^{th} Annual Technical Conference Proceedings, p. 318 (1993)). Despite this barrier improvement, there has been little commercial implementation of this approach, for several reasons. First, melt extrusion of a second polymer onto a polymeric/inorganic oxide film imparts substantial thermal stress to the preformed structures, often severely compromising their barrier performance. Second, structures with two different polymers are inherently more difficult to recycle than structures composed of only one polymer. Third, co-extrusion of a second polymer onto preformed rigid containers is nearly impossible with current technology and is cost prohibitive for large volume applications in the food and beverage industry.

Yet another method has been fully explored to address this problem and has achieved promising results in barrier improvement. This method applies onto the inorganic oxide layer a top coat comprised of soluble organic compounds having a plurality of carboxyl, hydroxyl, or carboxamide functional groups. See, e.g., PCT WO 02/16484. This top coat blocks ingress or egress of gas or vapor through the pinholes and achieves a barrier improvement of 5 to 10 times or more, and improves the abrasion resistance of bottles coated with an inorganic oxide. One problem with these compounds, however, is their inherent water solubility. The top coat thus has a less than optimum water resistance. Some of the soluble compounds also do not adhere effectively to the inorganic oxide coating surface. It therefore would be advantageous to reduce or eliminate the problem of gas or vapor permeability through pinholes in the inorganic oxide layer of a multi-layered structure by providing a top coat layer that has improved adhesion to the inorganic oxide layers, good water resistance, and enhanced barrier performance.

Others have used UV-cured acrylic oligomers, organic solvent based epoxy-amine cured polymers, or halogenated organic formulations (e.g., polyvinylidene chloride) as barrier coatings or protective films for PET substrate/silica constructions. It would be highly preferable to achieve the barrier and coating performance requirements described above with a water-based, 100% VOC-free, and halogen-free coating composition.

It would therefore be desirable to provide barrier coated plastic structures having enhanced gas barrier properties and improved water resistance, particularly where the top coating exhibits good adherence to the underlying structure. It would also be desirable to provide compositions and methods for improved adhesion of a top coat layer to an inorganic oxide layer, wherein the top coat fills any pinholes in the inorganic oxide layer and reduces the gas permeability of the multilayer structure. It would be further desirable to provide barrier coatings and methods that are water-based and substantially or completely free of volatile organic solvents and halogens.

### SUMMARY OF THE INVENTION

Compositions and methods are provided to give inorganic oxide coated polymeric structures a top coat that improves the gas barrier properties of the structure while enhancing the water resistance of the top coating and while improving the adhesion of the top coat to an inorganic oxide substrate layer. These top coat compositions comprise an organic barrier coating material in combination with a silane additive which crosslinks the organic compound with the inorganic oxide. Multilayer structures having this top coat are also provided, particularly in the form of containers for food and beverage packaging.

Containers employing the top coat meet the demanding requirements of most commercial applications. The containers demonstrate substantial water rinse resistance immediately after the top coat is dried, and coatings and bottles made with these coatings remain clear and adherent after more than 24 hours of soaking in room temperature water. Bottles having multilayer structures as described herein can provide a BIF of three or more, preferably five or more, even after abuse testing. For recycling purposes, these coatings can be removed during exposure to water at 80° C. at pH 12 or less. The coatings feel like PET plastic after water soak and are not slippery. They also can accept printing and adhesives, and provide improved gloss on the containers.

In preferred embodiments, the polymeric base layer is a thermoplastic polymer, particularly a polyester, such as polyethylene terephthalate (PET), and the inorganic layer is silica, metal oxide, or combination thereof. The top coat comprises an organic compound capable of reducing the permeability of the gas barrier layer to gas or vapor, and a silane additive crosslinking the organic compound and the inorganic oxide. The silane additive preferably is an organo silane, such as an epoxy silane or an amino silane, having a reactive group which bonds with a functional group of the organic compound. The organic compound, in addition to enhancing the gas barrier of the multilayer structure, preferably has a plurality of hydroxyl, carboxyl, or carbonyl functional groups. Desirably, the organic compound is polymeric. Preferred organic compounds include polyvinyl alcohols and polyhydroxyaminoethers.

Methods are also provided for reducing the permeability of vapor or gas though a multilayer structure comprising a polymeric base layer and an inorganic oxide gas barrier layer on a surface of the polymeric base layer. The methods include (i) applying to the inorganic oxide gas barrier layer a solution or emulsion, which comprises an organic compound capable of reducing the permeability of the multilayer structure to gas or vapor, and a silane additive capable of crosslinking the organic compound and the inorganic oxide, to form a top coat, and (ii) drying the top coat, thereby causing the silane additive to crosslink the organic compound with the inorganic oxide. The top coat solution or emulsion preferably is aqueous, and more preferably is free of halogenated compounds and volatile organic solvents. The solution or emulsion typically is applied to the inorganic oxide barrier layer by using a spray coating or dip coating technique. The drying and crosslinking preferably are conducted at a temperature less than 60° C.

Methods are provided for packaging a beverage. The steps include (i) providing a container comprising a polymeric container body and an inorganic oxide gas barrier layer on an exterior surface of the container body; (ii) applying to the inorganic oxide gas barrier layer a top coat of an organic compound capable of reducing the permeability of the gas barrier layer to gas or vapor, and a silane additive crosslinking the organic compound and the inorganic oxide; and (iii) depositing a beverage, such as a carbonated beverage, in the container.

### BRIEF DESCRIPTION OF THE DRAWINGS

FIG. 1 is an elevation view of a packaged beverage including a container coated with a gas or vapor barrier top coat in accordance with an embodiment of this invention.

FIG. 2 is a partial sectional view of the container in FIG. 1 illustrating the multilayer structure of the container.

### DETAILED DESCRIPTION OF THE INVENTION

A coated, multilayer structure is provided which comprises a polymeric base layer, an inorganic oxide gas barrier layer on the surface of the polymeric base layer, and an improved top coat on the inorganic oxide gas barrier layer. The top coat comprises an organic compound capable of reducing the permeability of the multilayer structure to gas or vapor and a silane additive which crosslinks the organic compound with the inorganic oxide gas barrier layer, thereby providing a top coat with enhanced adhesion to the inorganic oxide layer and improved water resistance. The top coat is particularly suitable for blocking ingress or egress of oxygen and carbon dioxide through polymeric packaging containers.

Composition for Forming the Top Coat

The coating compositions used for forming the top coat layer described herein is preferably is provided as a solution or emulsion containing (i) an organic compound that provides a gas and vapor barrier, and (ii) a silane additive dispersed/dissolved therein which serves as a cross-linking agent and adhesion promoter. The solution or emulsion, which is preferably aqueous-based, must be capable of forming a continuous film upon drying. In a particularly preferred embodiment, the aqueous solution or emulsion is free of both volatile organic solvents and halogenated compounds.

The Organic Compound

The organic compound desirably is selected to be capable of reducing the permeability of the multilayer structure (to optimize the barrier improvement) and should include one or more groups capable of bonding with the silane additive. The organic compound can be polymeric, oligomeric, or monomeric. Suitable organic compounds should have at least one, and preferably a plurality of, hydroxyl, carboxyl, carboxamide or other carbonyl functional groups.

Preferred organic compounds include polyvinyl alcohols (including modified polyvinyl alcohols) and polyhydroxyaminoethers. In a particularly preferred embodiment, the organic compound is a hydroxyl functionalized polyether ether, such as BLOX™ (The Dow Chemical Company, Midland, Mich., USA), which is a family of polyhydroxyaminoethers. BLOX 4000 Series Resins are particularly preferred, for their enhanced gas barrier properties. Examples of other suitable organic compounds include other polyetheramines and their salts, polyacrylic emulsions, emulsions and solutions of epoxy resins, urethane polymers, polyethyleneimine polymers, acrylic-urethanes, styrene-acrylic emulsions, polydextrose, polysaccharrides, and carboxy methyl cellulose.

Suitable organic compounds for forming the top coat are solid at temperature (25° C.) and pressure (atmospheric pressure). It is desirable that the organic compound for forming the top coat is non-toxic. It is also desirable that the interaction of the top coat with the inorganic oxide layer improves both water resistance and barrier properties.

Although there are many solid/solvent combinations that are effective in the methods described herein, it is preferred that both the solid and solvent be compatible with food and beverages. It is particularly preferred that both the solid (i.e. the organic compound) and solvent have regulatory approval for use in food-contact. It is especially preferred to use water as the solvent, due to its low cost, non-toxicity, and ease of handling.

The Silane Additive

The silane additive is a silane compound (R₄Si) which can be used to increase the adhesion and the water resistance of the top coat. The —R group can be alkoxy, halogen, or other functional or nonfunctional organic groups, although at least one of the —R groups must be reactive toward some functionality of the organic compound in order to effect the crosslinking. Halogenated compounds are not a preferred —R group.

Silanes hydrolyze in water to form usually unstable silanol (R₃Si—OH) and typically condense with themselves to form siloxanes (—RSi(OH)—O—Si(OH)—), which are essentially low molecular weight polymers having a reactive —OH group on each silicon atom. Hydrolysis is favored under acidic conditions, while condensation is favored under basic conditions. In either case, though, the Si—OH bond is reactive towards inorganic surface hydroxyl groups (M-OH) to form an M-O—-Si bond. Thus, at one end of the silane, the hydrolyzed silanol behaves as bonding agent to the inorganic oxide coating layer. Another —R group of the silanol is reactive with the organic compound. Thus, the silane acts as a curing agent to cross-link the polymer used as the top coating layer. The end result is therefore the enhanced adhesion of the top coating layer to the inorganic oxide barrier layer, resulting in improved mechanical, barrier, and water resistance properties of the polymer top coating layer. The silane treatment typically is not useful for coating the base polymer layer (i.e. without the inorganic oxide gas barrier layer interposed therebetween).

The silane additive preferably is an epoxy silane or an amino silane. In one embodiment, an epoxy silane is used in combination with a hydroxyl functionalized polyetheramine. Different epoxy silanes can be used, and the ratio of the polyetheramine (or their salts) and the epoxy silane will depend on the hydroxyl functionalized polyetheramines used.

Other classes of silanes that may be suitable include mercapto, methacroyl, vinyl, ureido, and isocyanato. The amount of silane additive in the top coat coating solution is suitably between about 0.5 and about 75 wt %, preferably between about 1 and about 20 wt %, more preferably between about 1.5 and about 15 wt %, of organic compounds. The amount of silane additive may be adjusted (increased or decreased) depending on the specific organic compound (e.g., polymer) being used.

The Multilayer Structure and Applying the Top Coat Thereto

The above-described top coat compositions are useful in methods for enhancing the gas or vapor barrier properties of a multilayer structure, which comprises a polymeric base layer and an inorganic oxide gas barrier layer on a surface of the polymeric base layer.

In one embodiment, a container having the multilayer structure is made by the following steps: (i) providing a polymeric base layer, or substrate; (ii) applying an inorganic oxide gas barrier layer to the base polymer layer; (iii) applying to the inorganic oxide gas barrier layer a solution or emulsion of a comprising the organic compound with silane additive to form a wet coating layer; and (iv) drying the wet coating layer and allowing the silane additive to crosslink the inorganic oxide gas barrier layer with the organic compound to form a continuous barrier enhancing top coat over and adhered to the inorganic oxide gas barrier layer. These steps, individually and in combination, can be conducted batchwise or in a continuous or semi-continuous process.

Polymeric Base Layer

The polymeric base layer preferably is a thermoplastic. Polyesters are particularly suitable, with polyethylene terephthalate (PET) being preferred for beverage packaging. Other suitable polyesters include polyethylene naphthalate (PEN), PET/PEN blends, PET copolymers, and the like. The base layer can be in the form of a flexible or rigid film or container. The coating compositions and methods described herein are most effective on substantially rigid containers, such as bottles.

Inorganic Oxide Layer

The inorganic oxide gas barrier layer preferably is composed of silica, a metal oxide, or combination thereof. Silica (SiOₓ) is particularly desirable for beverage containers because it is transparent, chemically inert and compatible with food and beverages. The inorganic oxide gas barrier layer preferably has a thickness between about 1 and about 100 nm. These inorganic oxide barrier layers often, and undesirably, have pinholes that allow passage of gas and vapor.

The inorganic oxide barrier coating can be applied to the polymeric base layer by a number of techniques. Examples of these techniques include sputtering and various types of vapor deposition, such as plasma vapor deposition, plasma enhanced chemical vapor deposition, and electron beam or anodic arc evaporative vapor deposition. Suitable vapor deposition techniques are described in U.S. Pat. No. 6,279,505 to Plester, et al., and U.S. Pat. No. 6,251,233, the disclosures of which are hereby expressly incorporated herein by reference. Alternatively, application of the inorganic oxide gas barrier layer can be conducted using a sol-gel process.

The Barrier Enhancing Top Coat

The top coat is applied to the inorganic oxide layer/polymer base layer to enhance the vapor or gas barrier of the structure. The top coat can be applied by dissolving the soluble organic compound in water or another suitable solvent (or emulsifying the organic compound in water or another liquid medium) and then applying the solution or emulsion to the inorganic oxide barrier layer using one of a variety of techniques known in the art. Examples of these coating techniques include dipping, flowing, or spraying. The application step may be followed by an optional step, such as spinning the coated bottle, to remove excess coating material, if needed. Application of the top coat preferably includes this spinning step. Following application of the solution or emulsion, the multilayer structure is allowed to dry such that the solvent evaporates, causing the organic compound to precipitate and/or coalesce and form a film, wherein the silane additive serves as a crosslinking agent between the inorganic oxide layer and the organic compound. When the solvent evaporates, the organic compound remains in the pinholes of the inorganic oxide barrier layer to block ingress or egress of gas or vapor. Preferably, the wet top coat is dried and crosslinked at a temperature less that 60° C. (e.g., less than 50° C., less than 40° C., less than 30° C., less than 25° C.). This low drying temperature (i.e. less than 60° C.) is important because some polymeric containers, such as PET bottles, deform and the inorganic oxide coating typically will crack if dried at a temperature higher than about 60° C.

The thickness of the top coat may vary and can be very thin. Some top coats can be applied at a thickness of 50 microns or less and some can be applied at a thickness of 10 microns or less. Preferably, the top coat has a thickness of less than 5 microns, more preferably less than 2 microns. It should be understood, however, that the thickness of the top coat can be greater than 50 microns.

Forms and Uses of the Multilayer Structures

The top coat coatings and methods are particularly useful for enhancing the gas or vapor barrier characteristics of containers such as food or beverage containers. The coatings and methods are particularly useful for enhancing the gas or vapor barrier characteristics of packaged food and beverage containers. The compositions and methods described herein preferably are used to form a coated plastic container comprising a plastic container body having an external surface and a coating on the external surface of the container. The coating provides a barrier that inhibits the flow of gas into and out of the container, which is particularly useful in producing carbonated beverages. For example, the gas barrier coating can protect the beverage from the flow of oxygen into the container from the outside or can inhibit the flow of carbon dioxide out of the beverage container. The resulting carbonated beverage has a longer shelf life because the coating on the container better holds the carbon dioxide within the container.

In the manufacture of packaged beverages, the top coat described herein can be applied to containers in a continuous packaged beverage manufacturing line between application of the inorganic oxide barrier layer to the container and filling the container with the beverage. Alternatively, the top coat possibly could be applied to the containers after they are filled with beverage. Regardless, the containers treated in accordance with these compositions and methods described herein can be used to manufacture packaged beverages in a conventional packaged beverage manufacturing facility. Such beverages desirably may be a carbonated beverage, such as a soft drink or beer, or a non-carbonated beverage, such as a juice-containing beverage.

An additional benefit of the compositions and structures described herein is that, in addition to enhancement of the barrier properties of polymeric/inorganic oxide structures, the top coat provides a method to increase the abuse resistance of such structures. Specifically, if film-forming polymeric materials are used as the organic compound, then deposition of those polymers onto the surface of the inorganic oxide layer can increase the abuse resistance of that layer. This is particularly useful in manufacturing packaged beverages because of the necessary mechanical handling of the treated containers.

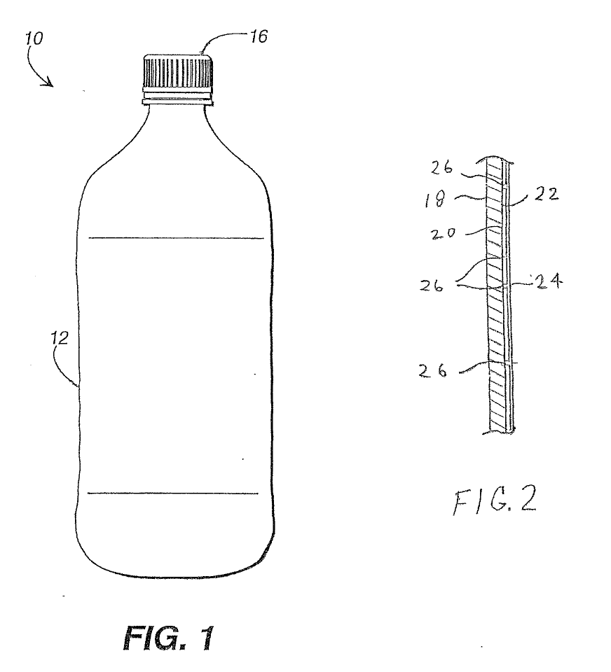

FIG. 1 illustrates a packaged beverage 10 comprising a container body 12, a beverage (not shown) disposed in the container, and a closure or cap 16 sealing the beverage within the container body. FIG. 2 illustrates the multiple layers of the container body including the polymeric base layer 18, the inorganic oxide gas or vapor barrier layer 20 on the exterior surface 22 of the base layer, and a vapor or gas barrier enhancing top coat 24 on the inorganic oxide barrier layer. Suitable polymers for forming the polymeric base layer 14 of the multilayer structure container 12 can be any thermoplastic polymer suitable for making containers, but preferably is PET. The inorganic oxide barrier layer 20 reduces the permeability of the container 10 to gas and vapor, particularly carbon dioxide and oxygen. The inorganic oxide barrier layer 20 suitably comprises silica. The top coat 24 is applied so as to enhance the vapor or gas barrier of the multilayer structure container 12. The top coat 24 illustrated in the FIG. 2 is continuous on the surface of the inorganic oxide barrier coating, but can be discontinuous. The top coat 24 covers the pinholes 26 in the inorganic oxide gas barrier layer and reduces the permeability of the container 12 to gas or vapor.

The phrase “covers the pinholes” includes bridging the pinhole, filling the pinhole (partially or completely), or a combination thereof, effective to increase the resistance for a gas to diffuse through the pinhole. The top coat adheres to the inorganic coating and is physically attracted (polar-polar attraction) to the PET base layer, where exposed through pinholes, thereby permitting the use of very thin top coats (e.g., less than about 2 microns), just enough to cover the pinholes.

The present invention will be further understood with reference to the following non-limiting examples.

### EXAMPLES

In the following examples, SiOₓ-coated PET bottles were subjected to various treatments that demonstrate the barrier-enhancing effect of the present compositions and methods. Barrier improvement and water resistance of the coating were assessed.

The barrier improvement factor (BIF) was determined by comparing the loss rates for containers with different coating compositions and layer structures. For example, the BIF of a plain, uncoated PET bottle is 1. Assuming the shelf life of a carbonated beverage packaged in a plain, uncoated PET bottle is about 10 weeks, the shelf life of a carbonated beverage in a coated PET bottle having a BIF of 1.2 would be about 12 weeks, the shelf life of a carbonated beverage in a coated PET bottle having a BIF of 2 would be about 20 weeks, and the shelf life of a carbonated beverage in a coated PET bottle having a BIF of 20 would be about 200 weeks. BIF can be measured using empty bottles with GMS (Gebele Measurement System) at 38° C. In these examples, the CO₂ loss rate was measured by determining the rate that CO₂ migrated to the exterior of the bottle, when the bottles were pressurized to 5 bar pressure and held at 38° C.

Water resistance was measured by immersing the top coated bottles in 22° C. water for 24 hours, either 5 minute or 24 hours after the top coat was applied. The bottles then were rubbed continuously with firm finger pressure while immersed during the first 5 minutes of immersion. The appearance and feel of the coating was then observed. It was also determined whether any coating particles had dissolved into the water by, first, visually inspecting the water and bottle under light, and then comparing the weight of the coated bottles coating before and after the water resistance test. For example, when BLOX™ was used as the top coat, a white haze was observed in the water if the coating dissolved into the water. These tests were repeated every hour for the first five hours, and then again 24 hours after immersion. The top coat was considered water resistant (i.e. the coating passes the water resistance test) when (i) no coating can be rubbed off and no coating dissolves into the water following 24 hour immersion in water at 22° C., (ii) the coating of the bottles, while in the water, do not feel sticky.

### Example 1

Water Resistance of BLOX™ Coating With and Without Silane Additive on SiOₓ-Coated PET Bottles

SiOₓ coated PET bottles were prepared and coated with either a BLOX 4000 top coat (20% or 5%) alone or a BLOX 4000 top coat (20% or 5%) containing epoxy silane (3-glycidoxypropyltrimethoxysilane, CAS #[2530-83-8]) (2% or 0.5%). The percentages refer to the solids content in the coating mixture. The bottles were then tested for water resistance (WR). The results are shown in Table 1.

TABLE 1
Water Resistance of BLOX^{TM}-Coated SiOₓ-Coated PET Bottles

| | | 20% BLOX + | | 5% BLOX + |
|---|---|---|---|---|
| WR | | 2% epoxy | | 0.5% epoxy |
| Test | 20% BLOX | silane | 5% BLOX | silane |
| 5 min. after | Coating | Pass | Coating Pass | Pass |
| bottles coated | dissolved immediately | | surface felt | |
| | | | sticky upon | |
| | | | contact with | |
| | | | water; coating | |
| | | | dissolved | |
| 24 hr. after | Coating | Pass | Coating dissolved | Pass |
| bottles coated | dissolved | | | |

### Example 2

Water Resistance of BLOX™ Coating With and Without Silane Additive Directly on PET Bottles

PET bottles were prepared and coated with either a BLOX 4000 top coat (20%) alone or a BLOX 4000 top coat (20%) containing epoxy silane (3-glycidoxypropyltrimethoxysilane) (2%). The bottles were then tested for water resistance (WR). The results are shown in Table 2.

TABLE 2
Water Resistance of BLOX ™-Coated PET Bottles

| WR | | 20% BLOX + 2% epoxy |
|---|---|---|
| Test | 20% BLOX | silane |
| 5 min. after | Coating hazy after 30 s | Coating dissolved and hazy |
| bottles coated | contact with water; coating | within 30 s contact with |
| | dissolved in water | water |

### Example 3

Barrier Improvement of BLOX™ Coating With and Without Silane Additive

PET bottles and SiOₓ-coated PET bottles were prepared and coated with either a BLOX 4000 top coat (20% or 10%) alone or a BLOX 4000 top coat (20% or 5%) containing epoxy silane (3-glycidoxypropyltrimethoxysilane, CAS #[2530-83-8]) (2% or 1%). The bottles were then tested for barrier improvement factor (BIF) relative to uncoated PET bottles. The results are shown in Table 3.

TABLE 3
BIF of Various BLOX ™/Silane Additive/SiOₓCoatings

| Bottle Structure | BIF |
|---|---|
| PET | 1 |
| PET + SiOₓ | 2.24 |
| PET + 20% BLOX | 1.91 |
| PET + 20% BLOX + 2% silane | 1.51 |
| PET + SiOₓ + 20% BLOX | 9.5 |
| PET + SiOₓ + 10% BLOX + 1% silane | 5.08 |
| PET + SiOₓ + 20% BLOX + 2% silane | 6.40 |

### Example 4

Barrier Improvement of PVOH Coating With and Without Silane Additive

PET bottles and SiOₓ-coated PET bottles were prepared and coated with either a polyvinyl alcohol (PVOH) top coat alone or a PVOH top coat top coat containing epoxy silane (3-glycidoxypropyltrimethoxysilane, CAS #[2530-83-8]). In a representative formulation, an aqueous solution was prepared which contained 5.0 wt % CELVOL 125 polyvinyl alcohol (Celanese), 1.5 wt % citric acid, and 0.5 wt % epoxysilane. The bottles were then tested for barrier improvement factor (BIF) relative to uncoated PET bottles. The results are shown in Table 4.

TABLE 4
BIF Comparison of Various PVOH/Silane Additive/SiOₓCoatings

| Bottle Structure | BIF |
|---|---|
| PET | 1 |
| PET + SiOₓ | 2.21 |
| PET + PVOH | 5.13 |
| PET + PVOH + epoxy silane | 5.08 |
| PET + SiOₓ + PVOH | 6.63 |
| PET + SiOₓ + PVOH + epoxy silane | 6.15 |

### Example 5

Water Resistance of BLOX™-Coated PET Bottles Using Different Silane Additives

PET bottles were prepared and coated with a BLOX 4000 top coat (20%) containing various silane additives, at a concentration of about 1 to 2 wt % of the total solid content. The bottles were then tested for water resistance (WR). The results are shown in Table 5.

TABLE 5
Water Resistance With Various Silane Additives

| | WR 5 min. | WR 24 hr |
|---|---|---|
| Silane Additive | after coating | after coating |
| 3-glycidoxypropyltrimethoxysilane | Pass | Pass |
| Diethoxy(3-glycidyloxypropyl)methylsilane | Pass | Pass |
| Methyltriethoxysilane | Pass | Pass |
| 3,4-epoxycyclohexylethyltrimethoxysilane* | Pass | Pass |
| Glycerol propoxylate triglycidyl ether | Fail | Fail |

*The reaction time was much longer due to the insolubility of 3,4-epoxycyclohexylethyltrimethoxysilane in water

### Example 6

Barrier Improvement of BLOX™ Coating, With and Without Silane Additive, Following Storage

PET bottles and SiOₓ-coated PET bottles were prepared and coated with a BLOX top coat containing an epoxy silane. The bottles were then subjected to storage conditions at 40° C., 95% RH for 3 days, either empty or filled with 4 volumes (measured at 4° C.) of carbonated water. Then, the bottles were tested for barrier improvement factor (BIF) relative to uncoated, unstored PET bottles. The results are shown in Table 6.

TABLE 6
BIF Comparison of Coated Bottles for Various Storage Conditions

| Bottle Structure | Storage Condition | BIF |
|---|---|---|
| PET | No storage | 1 |
| PET | Filled storage | 1.03 |
| PET | Empty storage | 1.08 |
| PET + SiOₓ | No storage | 1.97 |
| PET + SiOₓ | Filled storage | 1.28 |
| PET + SiOₓ | Empty storage | 1.61 |
| PET + SiOₓ + BLOX + epoxy silane | No storage | 6.40 |
| PET + SiOₓ + BLOX + epoxy silane | Filled storage | 5.29 |
| PET + SiOₓ + BLOX + epoxy silane | Empty storage | 4.23 |

### Example 8

Acrylic Top Coat With and Without Silane Additive

SiOₓ-coated PET bottles were prepared and coated with either an acrylic top coat alone or an acrylic top coat containing epoxy silane. The bottles were then tested for water resistance and barrier. The results are shown in Table 8.

TABLE 8
Performance of Acrylic Top Coat on SiOₓ-Coated PET Bottles

| Coating Description | Water Resistance | BIF* |
|---|---|---|
| PET + SiOx | N/A | 1 |
| PET + SiOx + acrylic | Coating turned hazy and could be | 1.11 |
| coating | removed after 1 hr immersion in 22 | |
| | ° C. water | |
| PET + SiOx + acrylic | Coating passed after 25 hr immersion | 1.24 |
| coating + epoxy silane | in 22° C. water | |

*Because different batches of SiOx coated PET bottles were used, the BIF relative to SiOx coated PET was reported instead of the BIF relative to PET bottles.

Those skilled in the art will recognize, or be able to ascertain using no more than routine experimentation, many equivalents to the specific embodiments of the invention described herein. The references cited herein are hereby incorporated by reference.

We claim:

1. A coated multilayer structure comprising:
a polymeric base layer;
an inorganic oxide gas barrier layer on a surface of the polymeric base layer; and
a top coat on the inorganic oxide gas barrier layer, the top coat comprising (i) an organic compound capable of reducing the permeability of the gas barrier layer to gas or vapor, and (ii) a silane additive crosslinking the organic compound and the inorganic oxide.

2. The structure of claim 1, wherein the organic compound and silane additive are applied to the inorganic oxide gas barrier layer in a solution or emulsion and then are crosslinked and dried.

3. The structure of claim 2, wherein the drying and crosslinking is done at a temperature less than 60° C.

4. The structure of claim 2, wherein the solution or emulsion is free of volatile organic solvents and halogen compounds.

5. The structure of claim 2, wherein the solution or emulsion comprises less than 15% silane additive by weight of organic compound.

6. The structure of claim 1, wherein the silane additive is an organo silane.

7. The structure of claim 6, wherein the organo silane comprises an epoxy silane or an amino silane.

8. The structure of claim 1, wherein the silicon (Si) atom of the silane additive is bonded to a surface hydroxyl group of the inorganic oxide (M-OH) to form an M-O—Si bond.

9. The structure of claim 8, wherein the silane additive comprises a reactive group which is bonded to a functional group of the organic compound.

10. The structure of claim 1, wherein the organic compound has at least one hydroxyl, carboxyl, or carbonyl functional group.

11. The structure of claim 1, wherein the organic compound is polymeric.

12. The structure of claim 1, wherein the organic compound is selected from the group consisting of polyetheramines, poly(acrylamide)s, polydextrose, polysaccharrides, poly(acrylic acid)s, epoxy resins, urethane polymers, polyethyleneimines, acrylic urethanes, styrene acrylics, and carboxymethyl celluloses.

13. The structure of claim 1, wherein the organic compound is selected from the group consisting of polyvinyl alcohols and polyhydroxyaminoethers.

14. The structure of claim 13, wherein the organic compound is a hydroxylated polyetheramine.

15. The structure of claim 1, wherein the top coat has a thickness of less than 5 microns.

16. The structure of claim 15, wherein the top coat has a thickness of less than 2 microns.

17. The structure of claim 1, wherein the inorganic oxide gas barrier layer has pinholes and the top coat covers the pinholes.

18. The structure of claim 1, wherein the inorganic oxide gas barrier layer is an SiOₓ coating.

19. The structure of claim 1, wherein the base layer is a thermoplastic layer.

20. The structure of claim 19, wherein the base layer comprises polyethylene terephthalate.

21. The structure of claim 1, wherein the multilayer structure is a container.

22. The structure of claim 20, wherein the base layer forms a container body and the gas barrier layer is on an exterior surface of the container body.

23. A packaged beverage comprising the container of claim 22 and a beverage disposed in the container.

24. The packaged beverage of claim 23, wherein the beverage is a carbonated beverage.

25. A method for reducing the permeability of vapor or gas though a multilayer structure comprising a polymeric base layer and an inorganic oxide gas barrier layer on a surface of the polymeric base layer, the method comprising:
applying to the inorganic oxide gas barrier layer a solution or emulsion comprising (i) an organic compound capable of reducing the permeability of the multilayer structure to gas or vapor, and (ii) a silane additive capable of crosslinking the organic compound and the inorganic oxide, to form a top coat, and
drying the top coat, thereby causing the silane additive to crosslink the organic compound with the inorganic oxide.

26. The method of claim 25, wherein the drying and crosslinking are conducted at a temperature less than 60° C.

27. The method of claim 25, wherein the solution or emulsion is aqueous.

28. The method of claim 27, wherein the solution or emulsion is free of halogenated compounds and volatile organic solvents.

29. The method of claim 25, wherein the solution or emulsion is applied to the inorganic oxide barrier layer by a spray coating or dip coating technique.

30. The method of claim 25, wherein the multilayer structure is a container.

31. The method of claim 30, wherein the base layer forms a container body, and the gas barrier layer is applied to an exterior surface of the container body.

32. A method of packaging a beverage comprising:
providing a container comprising a polymeric container body and an inorganic oxide gas barrier layer on an exterior surface of the container body;
applying to the inorganic oxide gas barrier layer a top coat comprising (i) an organic compound capable of reducing the permeability of the gas barrier layer to gas or vapor, and (ii) a silane additive crosslinking the organic compound and the inorganic oxide; and
filling the container with a beverage.

33. The method of claim 32, wherein the beverage is a carbonated beverage.

34. The method of claim 32, wherein the beverage is a carbonated soft drink.

35. The method of claim 32, wherein the beverage is beer.

36. The method of claim 32, wherein the beverage is a juice-containing beverage.
